(19) United States
(12) Patent Application Publication
(10) Pub. No.: US 2013/0111391 A1
(43) Pub. Date: May 2, 2013

(54) ADJUSTING CONTENT TO AVOID OCCLUSION BY A VIRTUAL INPUT PANEL

(71) Applicants: Nathan Robert Penner, Mountain View, CA (US); Michelle E. Lisse, Kirkland, WA (US); Benjamin Edward Rampson, Woodinville, WA (US)

(72) Inventors: Nathan Robert Penner, Mountain View, CA (US); Michelle E. Lisse, Kirkland, WA (US); Benjamin Edward Rampson, Woodinville, WA (US)

(73) Assignee: MICROSOFT CORPORATION, Redmond, WA (US)

(21) Appl. No.: 13/287,036

(22) Filed: Nov. 1, 2011

(51) Int. Cl. G06F 3/048

(52) U.S. Cl. 715/773

(57) ABSTRACT

The display of a content area is automatically adjusted such that the display of a virtual input panel (e.g. virtual keyboard, gesture area, handwriting area, . . . ) does not occlude content with which the user is interacting. After adjusting the display of the content area, the content being interacted with is visible within the content area. The content area is automatically adjusted such that it remains visible during the interaction. In some situations, a content area may also be temporarily resized while the virtual input panel is displayed. When a zoom scale is set to automatically change in response to a change to the content area, the zoom scale may be set to a fixed percentage. When the virtual input panel is dismissed, the content area may be returned to its original configuration before the virtual input panel was displayed.

### BACKGROUND

Many computing devices use virtual keyboards to enter content. Deploying these virtual keyboards take up a portion of the available display space. Some computing devices have a fixed location for the display of the virtual keyboard. Other devices allow the virtual keyboard to be displayed at different locations on the display. Deploying the virtual keyboard leaves a limited amount of display space for the content that a user wants to edit.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The display of a content area is automatically adjusted such that the display of a virtual input panel (e.g. virtual keyboard, gesture area, handwriting area, . . . ) does not occlude content with which the user is interacting (the interaction area). After adjusting the display of the content area, the content being interacted with is visible within the content area. While the virtual input panel is displayed, the content area is automatically adjusted such that it remains visible during the interaction (e.g. adding new content causing a new line to appear, moving the cursor to another location). In some situations, a content area may also be temporarily resized while the virtual input panel is displayed. When a zoom scale is set to automatically change in response to a change to the content area, the zoom scale may be set to a fixed percentage before such that when the display of the content area is adjusted, the content within the content area does not change size. When the virtual input panel is dismissed, the content area may be returned to its original configuration before the virtual input panel was displayed.

### BRIEF DESCRIPTION OF THE DRAWINGS

FIG. 1 illustrates an exemplary computing device;

FIG. 2 illustrates an exemplary system for adjusting a display of a content area such that a display of a virtual input panel does not occlude an interaction area;

FIG. 3 shows a process for adjusting a display of a content area such that a display of a virtual input panel does not occlude an interaction area while interaction with content is occurring;

FIG. 4 illustrates a process for moving content and/or resizing a content area to attempt to avoid occlusion by a virtual input panel;

FIG. 5 illustrates a system architecture for adjusting a display of a content area such that a display of a virtual input panel does not occlude an interaction area; and

FIGS. 6-13 show exemplary displays illustrating adjusting a display of a content area in response to a determination that a virtual input panel would occlude an interaction area.

### DETAILED DESCRIPTION

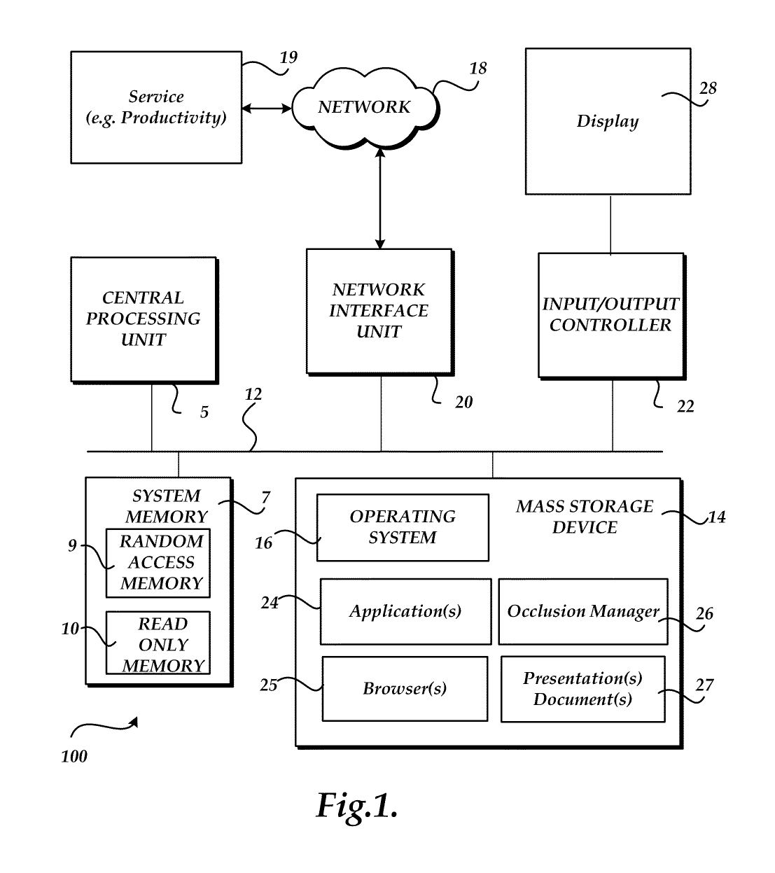

Referring now to the drawings, in which like numerals represent like elements, various embodiments will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer architecture for a computer 100 utilized in the various embodiments will be described. The computer architecture shown in FIG. 1 may be configured as a server computing device, a desktop computing device, a mobile computing device (e.g. smartphone, notebook, tablet . . . ) and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24, presentation(s)/document(s) 27, and other program modules, such as Web browser 25, and occlusion manager 26, which will be described in greater detail below.

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

According to various embodiments, computer 100 may operate in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. The computer 100 may also include an input/output controller 22 for receiving and processing input from a number of other devices, such as a touch input device. The touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display 28. The input/output controller 22 may also provide output to one or more display screens, a printer, or other type of output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, may be integrated with other components of the computer 100 on the single integrated circuit (chip).

As mentioned briefly above, a number of program modules and data files may be stored in the mass storage device 14 and RAM 9 of the computer 100, including an operating system 16 suitable for controlling the operation of a networked computer, such as the WINDOWS SERVER®, WINDOWS 7® operating systems from MICROSOFT CORPORATION of Redmond, Wash.

The mass storage device 14 and RAM 9 may also store one or more program modules. In particular, the mass storage device 14 and the RAM 9 may store one or more applications, such as a occlusion manager 26, productivity applications 24 (e.g. a presentation application such as MICROSOFT POWERPOINT, a word-processing application such as MICROSOFT WORD, a spreadsheet application such as MICROSOFT EXCEL, a messaging application such as MICROSOFT OUTLOOK, and the like), and may store one or more Web browsers 25. The Web browser 25 is operative to request, receive, render, and provide interactivity with electronic content, such as Web pages, videos, documents, and the like. According to an embodiment, the Web browser comprises the INTERNET EXPLORER Web browser application program from MICROSOFT CORPORATION.

Occlusion manager 26 may be on a client device and/or on a server device (e.g. within service 19). Occlusion manager 26 may be configured as an application/process and/or as part of a cloud based multi-tenant service that provides resources (e.g. services, data . . . ) to different tenants (e.g. MICROSOFT OFFICE 365, MICROSOFT WEB APPS, MICROSOFT SHAREPOINT ONLINE).

Generally, occlusion manager 26 is configured to automatically adjust the display of a content area such that the display of a virtual input panel (e.g. virtual keyboard, gesture area, handwriting area, and other software input panels) does not occlude content with which the user is interacting. After adjusting the display of the content area, the content being interacted with is visible within the content area. The content area is automatically adjusted such that the portion of content with which the user is interacting with remains visible during the interaction (e.g. adding new content causing a new line to appear, moving the cursor to another location). In some situations, a content area may also be temporarily resized while the virtual input panel is displayed. When a zoom scale is set to automatically change in response to a change to the content area, the zoom scale may be set to a fixed percentage before such that when the display of the content area is adjusted, the content within the content area does not change size. When the virtual input panel is dismissed, the content area may be returned to its original configuration before the virtual input panel was displayed. Additional details regarding the operation of occlusion manager 26 will be provided below.

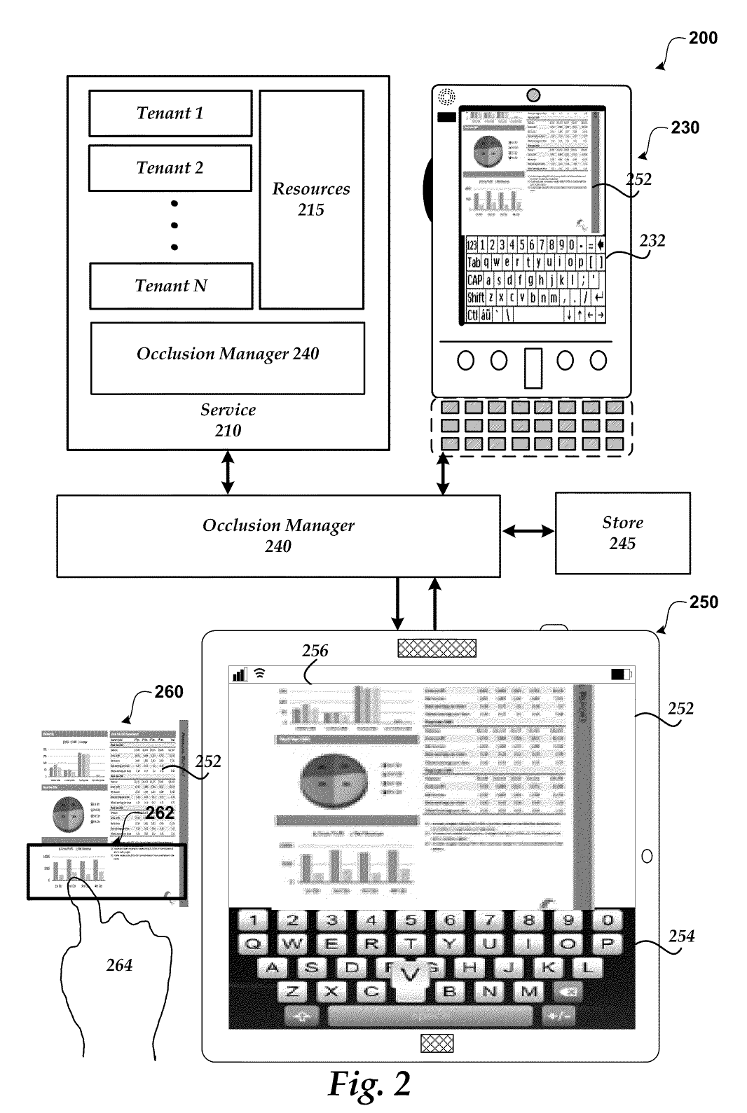

FIG. 2 illustrates an exemplary system for adjusting a display of a content area such that a display of a virtual input panel does not occlude an interaction area. As illustrated, system 200 includes service 210, occlusion manager 240, store 245, touch screen input device/display 250 (e.g. slate) and smart phone 230.

As illustrated, service 210 is a cloud based and/or enterprise based service that may be configured to provide productivity services (e.g. MICROSOFT OFFICE 365, MICROSOFT WEB APPS, MICROSOFT POWERPOINT). Functionality of one or more of the services/applications provided by service 210 may also be configured as a client based application. For example, a client device may include a presentation application used to display slides and the service 210 may provide the functionality of a productivity application. Although system 200 shows a productivity service, other services/applications may be configured to adjust the display of a content area so that display of a virtual input panel (e.g. 232, 254) does not occlude an area where the user is interacting with content (the interaction area).

As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/display 250 (e.g. a slate/tablet device) and mobile phone 230 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 shows an exemplary document 252 (e.g. a slide, a word-processing document, a spreadsheet document). Occlusion manager 240 is configured to receive input from a user (e.g. using touch-sensitive input device 250 and/or keyboard input (e.g. a physical keyboard and/or SIP)). For example, occlusion manager 240 may receive touch input that is associated with document 252. The touch input may indicate an area/object within the document that the user would like to interact with. For example, a user may tap on an object (e.g. a chart), a word in a line, a cell in a spreadsheet, a section within a document (e.g. notes, comments) to begin editing/interacting at the location of the selection. An area around/near this selection is referred to as an interaction area. The interaction area may be set to a predetermined size around the selection and/or may be determined based on a type of selection made by the user. For example, if a user selects a chart, the interaction area may include the entire chart. Whereas if the user selects a line of text to edit, the interaction area may include one or more lines above/below the selection. Generally, the interaction area is defined to be large enough to allow a user to edit the content without the content being occluded by the display of the virtual input panel.

Document 260 is intended to illustrate an initial display of document 252 before a virtual input panel (VIP) is displayed on a computing device (e.g. smartphone 230 and slate 250). In response to an interaction with the document, a determination is made as to whether a display of the VIP would occlude (e.g. cover) the interaction area that includes the content the user has selected. As illustrated, a user has used their finger 264 to select a graph located near the bottom left of document 252. If a VIP was to be displayed without any adjustment of the content area, the interaction area 262 would be occluded by the VIP. When the display of the VIP occludes the interaction area, the display of the content area is adjusted such that it does not occlude the interaction area. As illustrated, slate device 250 and mobile device 230 shows that the display of the content area has been moved upwards such that the chart within the interaction is not occluded by the VIP (e.g. VIP 254 and VIP 232). As discussed, the amount the display of the content area is adjusted is determined based on the configurable interaction area. For example, the display of the content area may be moved such that there is a predetermined amount of space for interacting with the content (e.g. a user can add two lines of content before the display of the content area is readjusted. According to an embodiment, the scale of the content remains the same as before the display of the content area is adjusted (e.g. the same zoom scale is maintained). The display of the content area may be adjusted using different methods. For example, the scroll region associated with the document may be adjusted to move the content in the interaction area such that it is not occluded when the VIP is displayed. A content area may also be resized such that at least the interaction area of the resized content area is visible to allow input. A content area may also be adjusted such that it covers a portion of other displayed content (e.g. one or more user interface elements such as a menu bar, a border of a window, a status display, and the like). More details are provided below regarding adjusting the display of the content area such that the interaction area as indicated by a user is not occluded by display of a VIP.

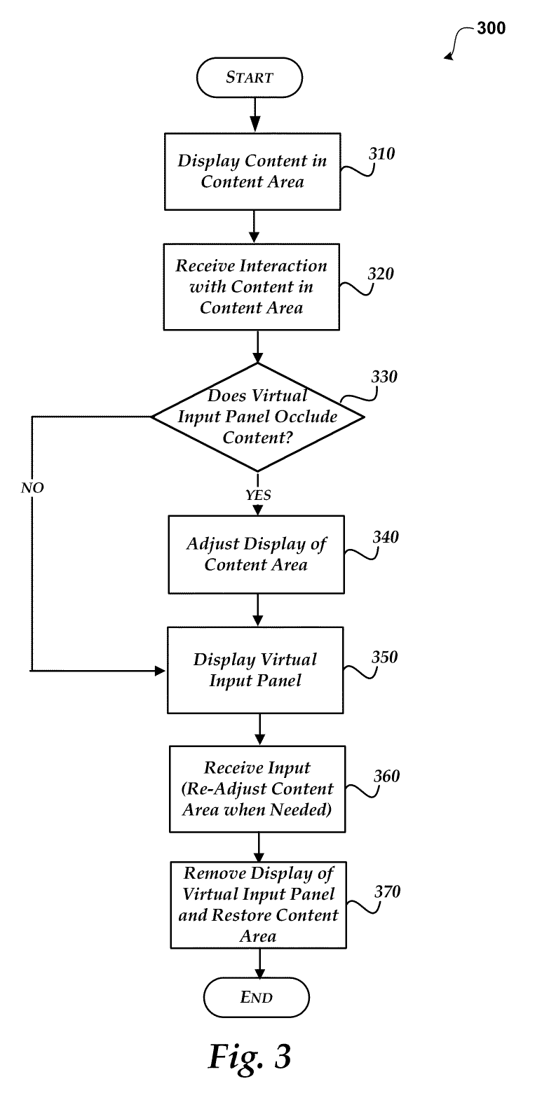

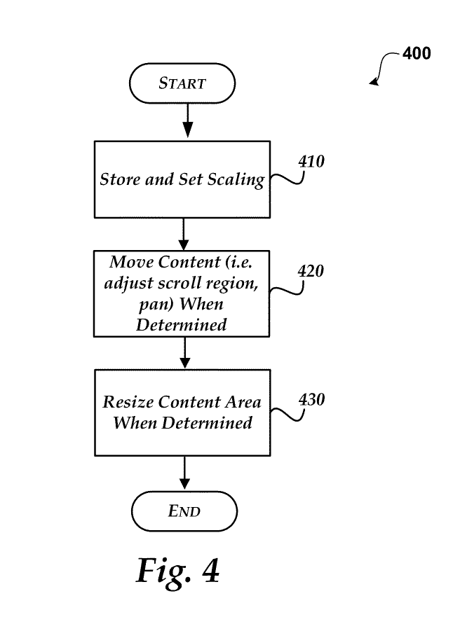

FIGS. 3-4 show an illustrative process for adjusting a display of a content area such that a display of a virtual input panel does not occlude an interaction area where interaction with content is occurring. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

FIG. 3 shows a process for adjusting a display of a content area such that a display of a virtual input panel does not occlude an interaction area while interaction with content is occurring.

After a start operation, the process flows to operation 310 where content is displayed within a content area. The content may be any content that is displayed by an application. For example, the content may be a presentation slide, a word-processing document, a spreadsheet, a notes list, a web page, a graphics page, an electronic message, and the like. The display may include one or more content areas. For example, a document may have different sections of a document that are independently editable (e.g. cells, parts of a slide (e.g. title, sub-title, content . . . ), objects (e.g. tables, charts, objects, PIVOTTABLES . . . ), non-scrollable regions (e.g. notes section, comments section), and the like.

Moving to operation 320, the process receives interaction with content within the content area. The interaction may be a variety of different interactions, such as, but not limited to: touch input, mouse input, stylus input, and the like. The interaction indicates an interaction area where the user would like to interact with the content. For example, a user may tap on a word in a line, a cell in a spreadsheet, a section within a document (e.g. notes, comments) to begin editing/interacting at the location.

Flowing to decision operation 330, a determination is made as to whether the virtual input panel (VIP) that receives input to interact with the content would occlude the interaction area when displayed. According to one embodiment, the VIP is an element that may be displayed anywhere within the display (including covering content currently displayed). One or more VIPs may be configured to receive a variety of different input. For example, the VIP may be a virtual keyboard, a handwriting area, a gesture area, and the like. When the display of the VIP does not occlude the interaction area, the process moves to operation 350. When the display of the VIP does occlude the interaction area, the process moves to operation 340.

Transitioning to operation 340, the display of the content area is adjusted such that it does not occlude the interaction area. The display of the content area may be adjusted using different methods. For example, the scroll region may be adjusted to move the content in the interaction area such that it is not occluded when the VIP is displayed. A content area may also be resized such that at least the interaction area of the resized content area is visible to allow input. For example, instead of scrolling content an input panel may be temporarily resized. A combination of both may also be used. According to an embodiment, the scaling of the content within the content area may be temporarily scaled to display the interaction area without being occluded. A content area may also be adjusted such that it covers a portion of other displayed content (e.g. one or more user interface elements such as a menu bar, a border of a window, a status display, and the like).

Moving to operation 350, the VIP is displayed. The VIP may be displayed at any determined location within the display that shows the content area. For example, the VIP may be displayed at the top of the display, the bottom of the display, the side of the display, within the middle of the display, and the like. Different VIPs may be displayed depending on the interaction (e.g. a virtual keyboard to receive keyboard input, a virtual gesture panel to receive a touch gesture, a handwriting input panel to receive a signature, and the like). The VIPs may be a variety of different sizes. For example, a larger VIP may cause the display of the content area to be adjusted, whereas a smaller VIP does not cause the display of the content area to be adjusted.

Flowing to operation 360, input is received when the VIP and the content within the interaction area is displayed. As long as the VIP is displayed, a determination is made as to whether the display of the content area needs to be adjusted such that it is not occluded in response to the user interaction. For example, the editing may cause one or more new lines to be inserted (e.g. typing, pasting content) within the content area that if the display of the content area was not adjusted would be occluded. A user may also select another location within the content when the VIP is displayed. The display of the content area is adjusted such that the content in the interaction area remains visible to the user.

Transitioning to operation 370, the display of the VIP is removed and the display of the content area may be returned to a display as it was before adjusting the display of the content area.

The process then moves to an end operation and returns to processing other actions.

FIG. 4 illustrates a process for moving content and/or resizing a content area to attempt to avoid occlusion by a virtual input panel.

After a start operation, the process 400 flows to operation 410, where the scaling information for the display of the content area is determined and stored. For example, when the scaling is “Fit to Content Area”, the scaling factor is saved as an explicit value (e.g. 65%, 90%, 100% . . . ). According to an embodiment, when the VIP is displayed, the size of the content in the content area remains at the same zoom scale as before the VIP is displayed (e.g. the content does not get smaller in response to the VIP being displayed). When the VIP is dismissed from the display, the scale may be reset to the stored scaling value.

Moving to operation 420, content within the content are is moved when determined. For example, the scroll position of the window may be adjusted to move the content within the content area such that it is not occluded when the VIP is displayed. The scrolling may be vertical and/or horizontal (panning). The content may also be moved to some other location to avoid occlusion by the display of the VIP.

Flowing to operation 430, the content area where the interaction area may be resized such that the display of the VIP does not occlude the interaction area. The interaction area may be within a section of a document that is not scrollable and would be fully occluded by the VIP when displayed. For example, a pane within the content area may be displayed to be taller than the VIP. When the VIP is dismissed, the pane restores to its original height.

The process then moves to an end operation and returns to processing other actions.

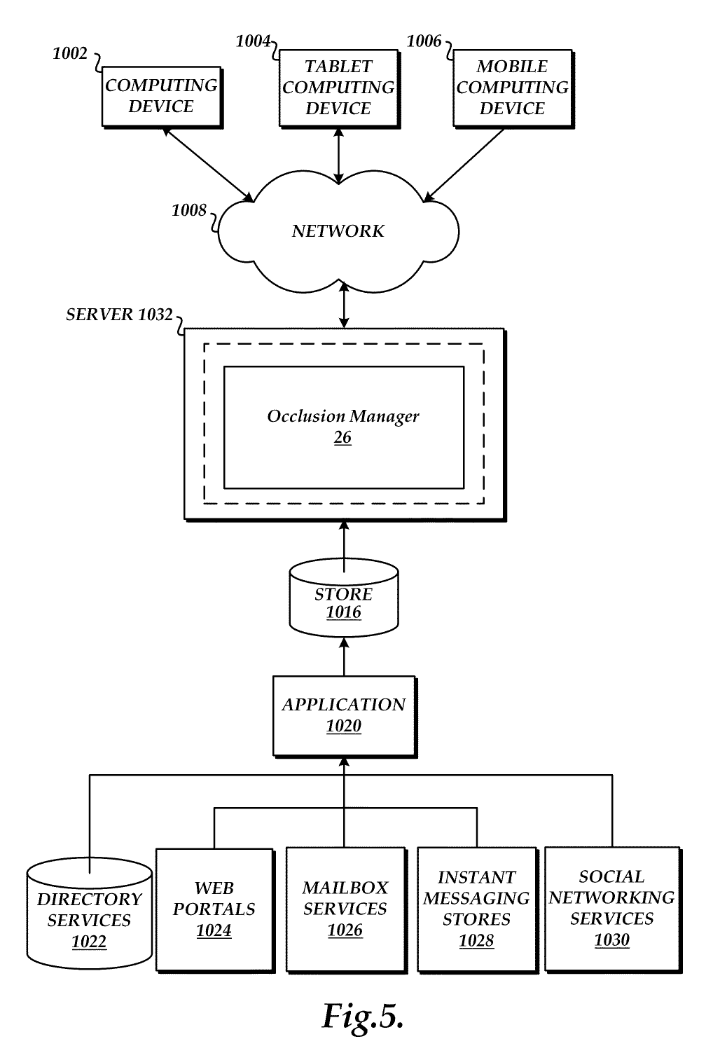

FIG. 5 illustrates a system architecture for adjusting a display of a content area such that a display of a virtual input panel does not occlude an interaction area, as described herein. Content used and displayed by the application (e.g. application 1020) and the occlusion manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to adjust the display of a content area such that display of a VIP does not occlude the interaction area. For example, server 1032 may generate displays for application 1020 to display at a client (e.g. a browser or some other window). As one example, server 1032 may be a web server configured to provide productivity services (e.g. presentation, word-processing, messaging, spreadsheet, document collaboration, and the like) to one or more users. Server 1032 may use the web to interact with clients through a network 1008. Server 1032 may also comprise an application program (e.g. a productivity application). Examples of clients that may interact with server 1032 and a presentation application include computing device 1002, which may include any general purpose personal computer, a tablet computing device 1004 and/or mobile computing device 1006 which may include smart phones. Any of these devices may obtain content from the store 1016.

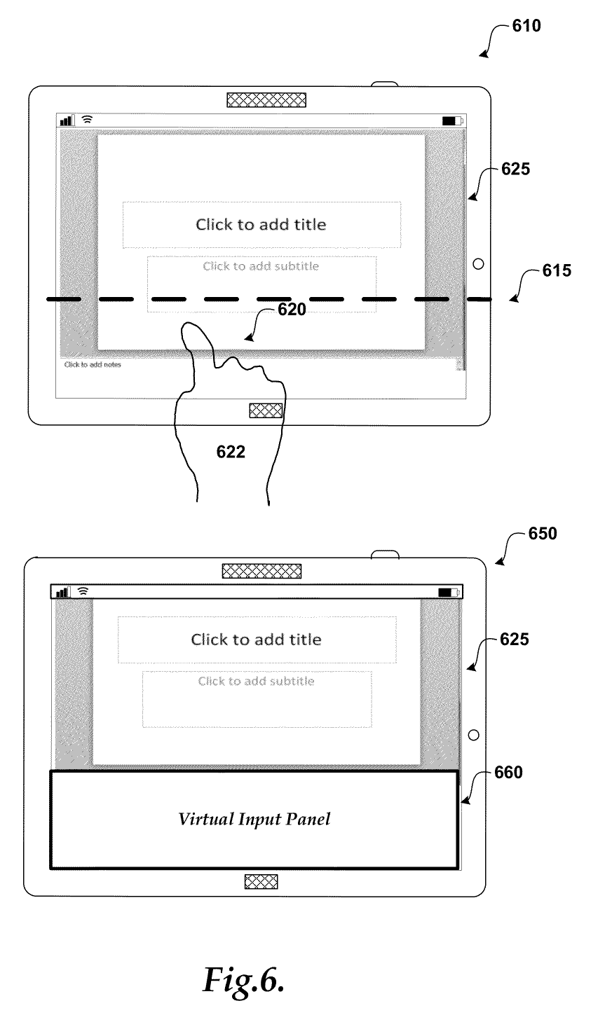

FIG. 6 shows exemplary landscape slate displays showing adjusting a content area associated with a presentation slide before displaying a VIP.

Display 610 shows a user 622 selecting a section 620 of a presentation slide 625. Line 615 indicates where a display of the VIP would cover the slide if displayed (line 615 is for illustration purposes and is not displayed). As can be seen, if VIP 660 is displayed without adjusting a display of the content area of the slide, the interaction area where the user has selected would be occluded by the VIP.

Display 650 shows that slide 625 has been moved upward to expose the interaction area indicated by the user before displaying VIP 660.

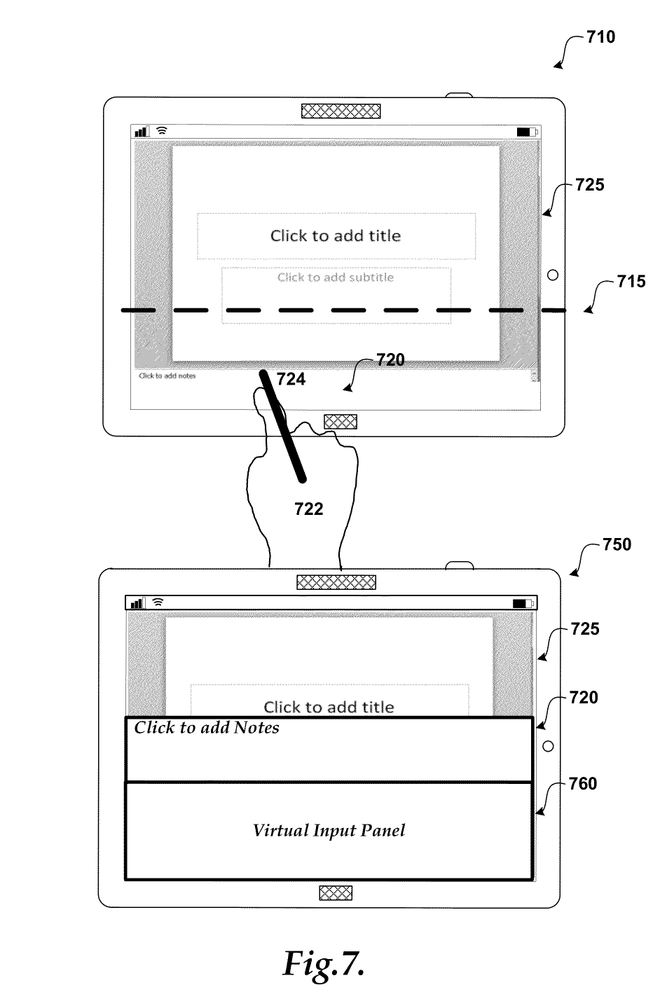

FIG. 7 shows exemplary landscape slate displays showing adjusting a size of a content area of a presentation slide before displaying a VIP.

Display 710 shows a user 722 selecting a section 720 of a presentation slide 725 using stylus 724. In the current example, section 720 is a notes section that is normally a constant sized area that is used to enter a few notes for the slide. Line 715 indicates where a display of VIP 760 would cover the slide if displayed without adjusting the display of the content. As can be seen, if the VIP is displayed without adjusting a display of the content of the slide, the interaction area including the notes section 720 where the user has selected would be occluded by the VIP 660.

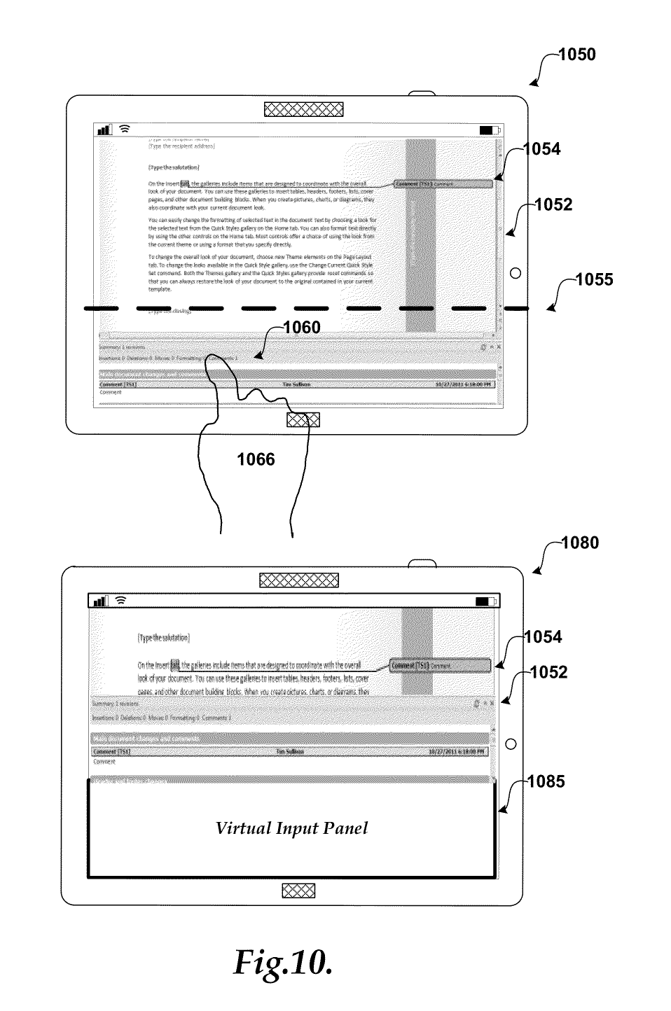

Display 750 shows that notes area 720 has been resized to a larger size before displaying the VIP 760. As can be seen, the user may now enter notes within note area 720 using VIP 760 without the notes being occluded by the display of VIP 760. In the current example, the display of slide 725 has remained in the same location. According to an embodiment, the display of the content area may also change (e.g. See FIG. 10) in addition to changing a size of a content area.

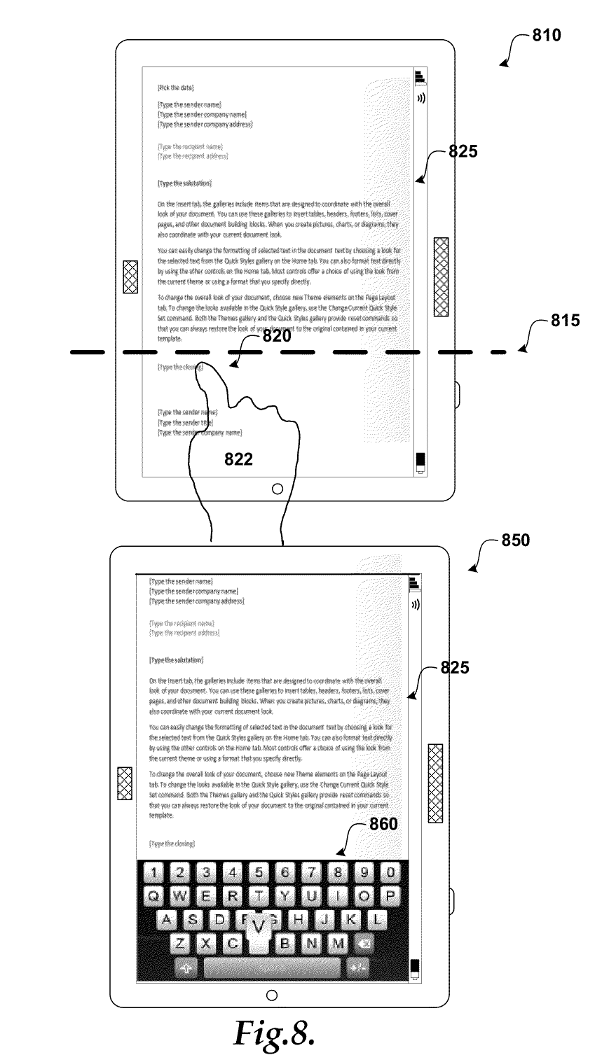

FIG. 8 shows exemplary slate displays in portrait mode showing adjusting a content area of a word-processing document before displaying a VIP.

Display 810 shows a user 822 selecting a section 820 of a word-processing document 825. Line 815 indicates where a display of VIP 860 would cover the slide if displayed. As can be seen, if the VIP is displayed without adjusting a display of the word-processing document, the interaction area where the user has selected would be occluded by the VIP. If the user selects at a location above line 815, the display of the content area is not adjusted.

Display 850 shows that word-processing document 825 has been moved upward to expose the interaction area indicated by the user before displaying the VIP 860. If the VIP 860 was to be displayed in a different area of the display, the display of the content area would be adjusted appropriately (e.g. scrolling the content down instead of up).

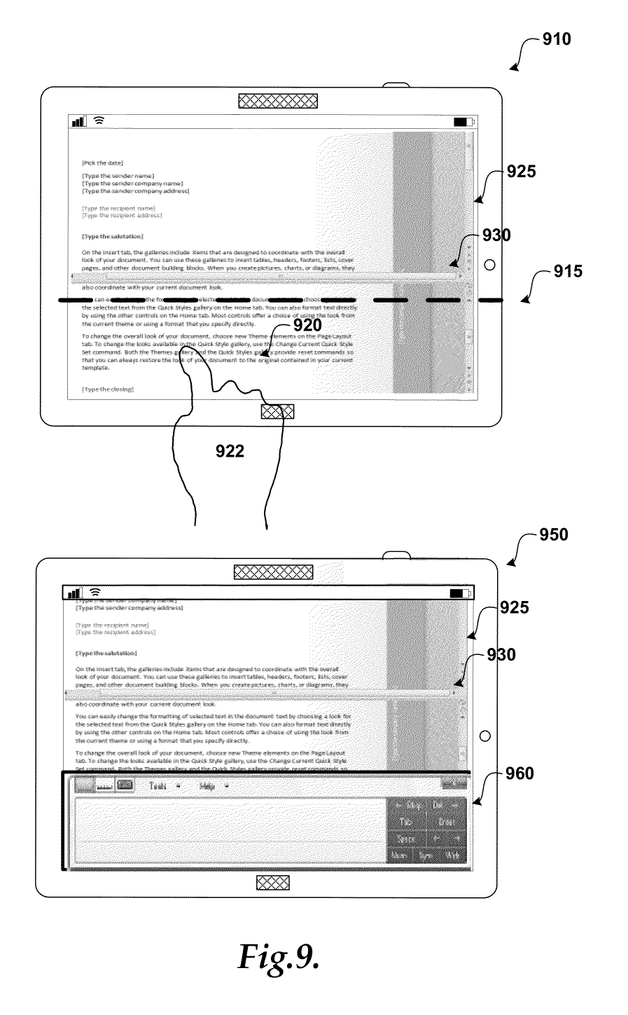

FIG. 9 shows exemplary slate displays in landscape mode showing adjusting a content area of a word-processing document before displaying a VIP.

Display 910 shows a user 922 selecting a section 920 of a word-processing document 925 that has been split by divider 930. Divider 930 divides the word processing document such that two different sections of the document may be viewed within the same display. Line 915 indicates where a display of the VIP 960 would cover the word processing document if displayed. As can be seen, if the VIP is displayed without adjusting a display of the word processing document, the interaction area would occlude almost the entire bottom section of the split document 925.

Display 950 shows that word-processing document 925 has been moved upward to expose the interaction area indicated by the user before displaying the VIP 960. According to another embodiment, the divider 930 may also be moved up to change a portion of the document that is displayed beneath the divider.

FIG. 10 shows exemplary slate displays in landscape mode showing adjusting a content area of a word-processing document and resizing a comment area before displaying a VIP.

Display 1050 shows a user 1066 selecting a comments area 1060 that is associated with word-processing document 1052. In the current example, a user has entered one comment 1054 that may be displayed with/without the display of the comments area 1060. Line 1055 indicates where a display of the VIP 1085 would cover the word processing document and comment if displayed. As can be seen, if the VIP is displayed without adjusting a display of the word processing document, the VIP 1085 would occlude the entire comment area.

Display 1080 shows that word-processing document 1052 has been positioned to expose the related comment that is associated with the user selection. The comment area 1060 has also been resized to allow a user to interact with the comments. As can be seen, the user not only can view the content for the comment in the comments area, the user can also see the comment in the document itself. When a user selects a different comment, the comments area and the content area of the word-processing document are adjusted such that the user can see both the comment in the document and the comment in the comments area. According to an embodiment, a user may determine what they would like displayed (e.g. just show the comments area and not the corresponding comment in the document).

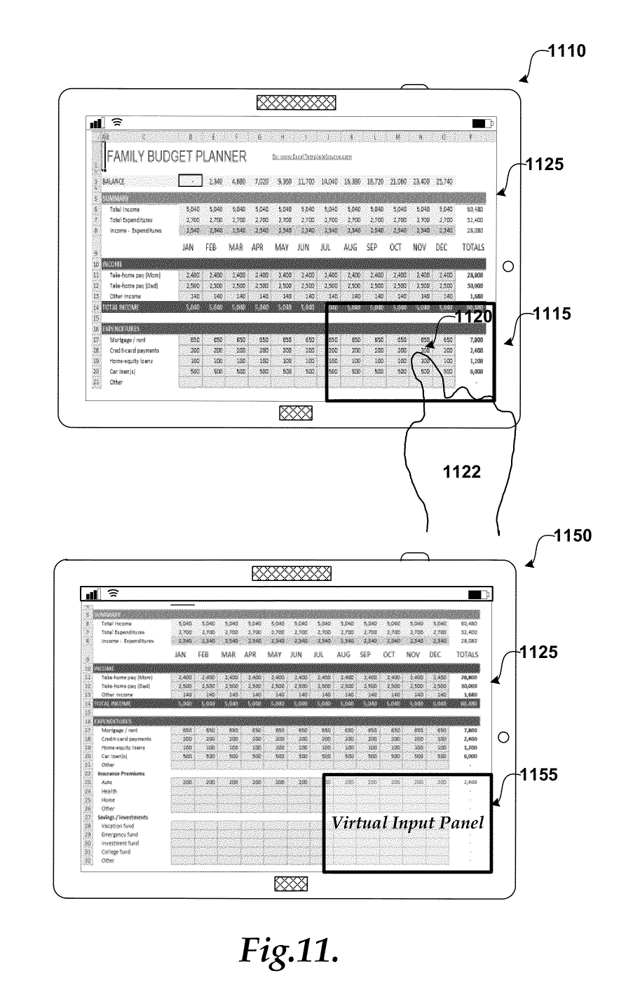

FIG. 11 shows exemplary slate displays in landscape mode showing adjusting a content area within a spreadsheet before displaying a VIP.

Display 1110 shows a user 1122 selecting a section 1120 of a spreadsheet 1125. Box 1115 indicates where a display of the VIP 1155 would cover the spreadsheet if displayed. As can be seen, if the VIP is displayed without adjusting a display of the spreadsheet, the VIP would occlude the selected content 1120. The VIP may be a variety of different sizes. For example, a larger VIP may cause the display of the content area to be adjusted, whereas a smaller VIP does not cause the display of the content area to be adjusted.

Display 1150 shows spreadsheet 1125 has been moved upward to expose the interaction area indicated by the user before displaying the VIP 1155. According to an embodiment, the VIP may be displayed transparently (e.g. alpha-blended) such that a portion of the content beneath the display of the VIP can also be seen. The transparency may be set to a predetermined level and/or the transparency level can change during the use of the VIP. For example, the transparency may automatically be removed when the user starts to interact with the VIP 1155.

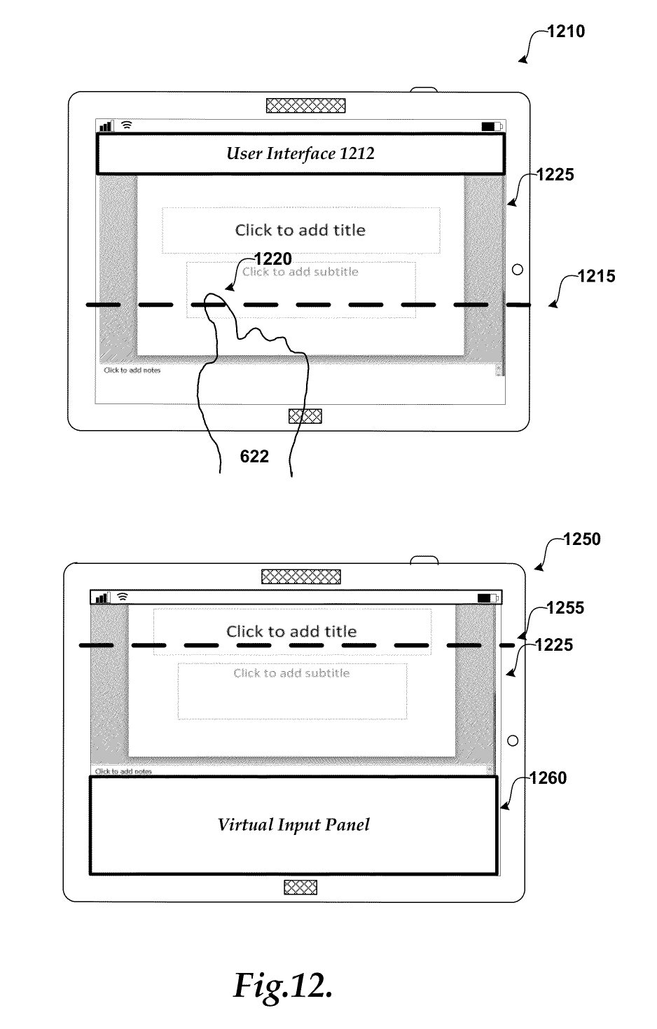

FIG. 12 shows exemplary landscape slate displays showing adjusting a display of a user interface associated with a presentation slide before displaying a VIP.

Display 1210 shows a user 622 selecting a section 1220 of a presentation slide 1225. Line 1215 indicates where a display of the VIP would cover the slide if displayed. As can be seen, the selection is very near a point where the VIP 1260 if displayed without adjusting a display of the content area of the slide would be occluded.

Display 1250 shows that slide 1225 has been moved upward to expose more interaction area before displaying VIP 1260 and displaying the slide 1225 over/instead of a display of user interface 1212. Line 1255 (shown for illustration purposes only) shows the additional portion of slide 1225 that can be seen by displaying the slide over/instead of the user interface 1212. As can be seen, by changing the display of the user interface 1212, the user is able to see the complete title section.

In some examples, the content area may remain as initially displayed and a displayed element(s) may be removed/drawn over to expose more content. For example, a user may select an item near user interface 1212 that would result in the slide 1225 being drawn over/instead of the user interface 1212.

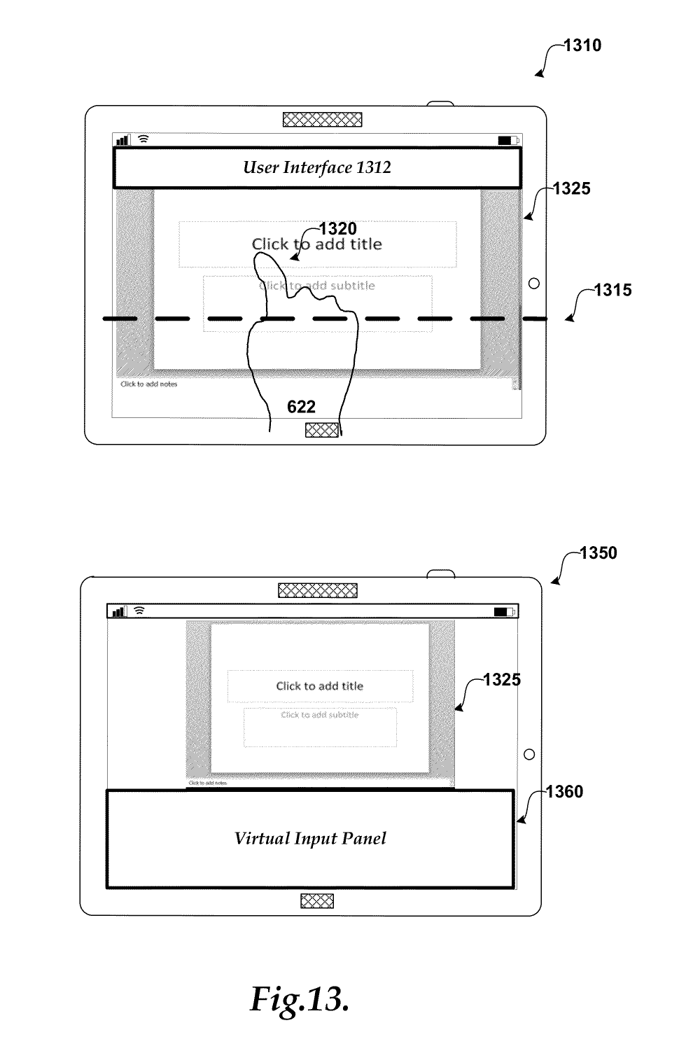

FIG. 13 shows exemplary landscape slate displays showing adjusting a display of a user interface associated with a presentation slide before displaying a VIP.

Display 1310 shows a user 622 selecting a section 1320 of a presentation slide 1325. Line 1315 indicates where a display of the VIP would cover the slide if displayed. In the current example, the interaction area has been determined to be a larger area as compared to the other examples (e.g. the entire slide). Even though the portion of the slide is not occluded by the display of VIP 1360, the content area is adjusted since the interaction area (e.g. the entire slide) is defined as the interaction area.

Display 1350 shows that slide 1325 has been moved upward and scaled to expose the entire slide before displaying VIP 1360. UI 1312 has also been removed/drawn over to increase the available display space.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for adjusting a content area to avoid occlusion by a display of a virtual input panel, comprising:
displaying a content area;
receiving an interaction with content that indicates an interaction area within the content area;
determining when a display of the virtual input panel occludes the interaction area; and
adjusting the display of the content area such that the display of the virtual input panel does not occlude the interaction area.

2. The method of claim 1, wherein adjusting the display of the content area comprises at least one of: scrolling the content area and moving the content area.

3. The method of claim 2, further comprising adjusting both a size of an area within the content area and moving a display of the content within the content area.

4. The method of claim 1, wherein the virtual input panel is one of: a virtual keyboard, a touch gesture input panel; a handwriting area, and a software input panel.

5. The method of claim 1, further comprising adjusting a size of an area within the content area such that at least a portion of the adjusted area is exposed when the virtual input panel is displayed.

6. The method of claim 5, wherein the area is at least one of: a notes area and a comments area.

7. The method of claim 1, further comprising displaying the virtual input panel alpha-blended such that at least a portion of content below the display of the virtual input panel remains visible.

8. The method of claim 1, further comprising automatically adjusting the content area when the virtual input panel is displayed before a portion of the content becomes occluded while the virtual input panel is displayed.

9. The method of claim 1, further comprising determining a current scaling factor before adjusting the adjusting the display of the content area and when the virtual input panel is removed from the display adjusting the content region back to the scaling factor.

10. A computer-readable medium having computer-executable instructions for adjusting a content region to avoid occlusion by a display of a virtual input panel, comprising:
displaying a content area;
receiving an interaction with content that indicates an interaction area within the content area;
determining a location to display the virtual input panel;
determining when a display of the virtual input panel at the determined location occludes the interaction area; and
adjusting the display of the content area such that the display of the virtual input panel does not occlude the interaction area.

11. The computer-readable medium of claim 10, wherein adjusting the display of the content area comprises at least one of: scrolling the content area and moving the content area.

12. The computer-readable medium of claim 10, wherein the virtual input panel is one of: a virtual keyboard, a touch gesture input panel; a handwriting area, and a software input panel.

13. The computer-readable medium of claim 10, further comprising adjusting a size of an area within the content area such that at least a portion of the adjusted area is exposed when the virtual input panel is displayed.

14. The computer-readable medium of claim 10, further comprising displaying the virtual input panel alpha-blended such that at least a portion of content below the display of the virtual input panel remains visible.

15. The computer-readable medium of claim 10, further comprising automatically adjusting the content area when the virtual input panel is displayed before a portion of the content becomes occluded while the virtual input panel is displayed.

16. The computer-readable medium of claim 10, further comprising determining a current scaling factor before adjusting the adjusting the display of the content area and when the virtual input panel is removed from the display adjusting the content region back to the scaling factor.

17. A system for adjusting a content region to avoid occlusion by a display of a virtual input panel, comprising:
a display;
a network connection that is coupled to tenants of the multi-tenant service;
a processor and a computer-readable medium;
an operating environment stored on the computer-readable medium and executing on the processor; and
a process operating under the control of the operating environment and operative to perform actions, comprising:
displaying a content area;
receiving an interaction with content that indicates an interaction area within the content area;
determining a location to display the virtual input panel;
determining when a display of the virtual input panel at the determined location occludes the interaction area; and
adjusting the display of the content area such that the display of the virtual input panel does not occlude the interaction area.

18. The system of claim 17, wherein adjusting the display of the content area comprises moving a portion of the content in content area.

19. The system of claim 17, further comprising adjusting a size of an area within the content area such that at least a portion of the adjusted area is exposed when the virtual input panel is displayed.

20. The system of claim 17, further comprising automatically adjusting the content area when the virtual input panel is displayed before a portion of the content becomes occluded while the virtual input panel is displayed.
